(19) United States
(12) Patent Application Publication
(10) Pub. No.: US 2006/0021495 A1
(43) Pub. Date: Feb. 2, 2006

(54) Electric percussion instruments

(76) Inventor: Paul John Freitas, Santa Cruz, CA (US)

Correspondence Address: PAUL J. FREITAS, 942 PELLEGRINI STREET, SANTA CRUZ, CA, 95062, US

(21) Appl. No.: 10/710,782

(22) Filed: Aug. 2, 2004

(51) Int. Cl. G10H 3/00

(52) U.S. Cl. 84/723

(57) ABSTRACT

An electric musical instrument transducer contains one or more air gapped parallel plate variable capacitors. Each variable capacitor in the transducer has one plate that comprises, covers, or is embedded within an acoustically emitting vibrating surface on a musical instrument (such as a drumhead or soundboard) while the other plate is a rigid surface held a fixed distance away. When the instrument is played, the vibrating surface causes vibrations directly (without using airborne sound as an intermediary) in the non-fixed plates of the variable capacitors, thus causing time-varying voltage oscillations in the variable capacitors that directly reflect the vibrational state, and therefore the sound, of the instrument. These voltage oscillations are then converted to signals that can be used by audio recording and amplification equipment.

### BACKGROUND OF INVENTION

This invention relates generally to the field of musical instruments, more particularly to an improved set of electric percussion instruments better adapted to interface with electronic recording and amplification equipment. There are two different models for percussion instruments in common usage at the time of this writing: acoustic and electronic. There is also a third model, electric percussion, which is less widely used. This invention relates to the third category. For completeness, all three categories will be discussed here.

Acoustic Percussion Instruments

Acoustic percussion instruments include a number of different types of drums (such as snare, tom, bass, conga, djembe, etc.) as well as cymbals (such as hi-hat, crash, ride, gong, etc). Acoustic percussion instruments can be widely varied, such as temple blocks and cowbells, but drums and cymbals are of particular interest to musicians. Usually a number of acoustic percussion instruments are placed together in sets to be used by a single musician. Such sets of instruments are often known as drumsets, and the musician playing them known as a percussionist or drummer.

Drums typically consist of a shell (a hollow open-ended cylinder made of materials such as wood, metal, and plastic) capped on one or both ends by a drumhead (a thin, flexible disc made of materials such as plastic or animal hide). Drumheads are typically held in place by metal hoops that are secured to the shell by tension rods screwed into metal lugs. Acoustic drums are played by striking one or both heads with hands, sticks, brushes, beaters, rods, and other such devices. It is interesting to note that on drums, the drumhead produces most of the sound of the device, which makes the drumhead a percussion instrument in and of itself. Some drums, such as single-headed toms, do little other than provide tension to a drumhead.

Acoustic cymbals are typically discs made of metals such as bronze or brass, often mounted on stands by holes in their centers. Cymbals can also be mounted on their perimeter (like gongs). They have been carefully machined and hammered to provide certain sounds in response to activating actions, for example when played by devices such as sticks, mallets, brushes, rods, or bows, or when brought into rapid contact with one another (as in the case with hi-hat cymbals).

Acoustic percussion instruments interface with electronic recording and amplification systems through microphones. There are two different techniques used to record percussion sounds: close micing, where one or more microphones are placed close to each percussion instrument to capture their sounds individually, and distance micing, where fewer microphones are placed further away from the set of instruments to capture their sounds collectively.

Close micing is often more desirable because it captures individual instrument sounds more accurately, which allows more precise mixing of percussion sounds in production. It is also more complicated, due to the number of microphones needed. In close micing double-headed drums like snare drums, for example, two microphones are needed for each drum, one for each drumhead. Close micing can be very costly, especially if high quality microphones are required (as is often the case for cymbals). Distance micing is less costly and complicated, but it offers less control of instrument sounds while mixing for recording and/or amplification. Distance micing is also more likely to pick up noises from the surroundings (like other instruments, vocals, crowd noise, etc.) and make the final musical mix less clean than close micing.

A combination of close and distance micing are commonly used in live performances and recording sessions. For example, two close microphones may be used on snare drums, but only one close microphone on each tom and bass drum (even though these instruments are typically double-headed). Some loss of fidelity is experienced on toms and bass drums because the microphone only captures the sound from the head being struck. For cymbals, one or two distant microphones are often used to capture their sounds collectively. The sounds of individual cymbals cannot be mixed individually, and other sounds (such as drum noise) are recorded as well.

Acoustic percussion instruments have a number of drawbacks. For greatest fidelity in an amplified performance or recording session, they require a large number of microphones, which can be quite expensive. Arranging these microphones requires great expertise, and can be quite time consuming. The fact that microphones can pick up any and all sounds present, not just the percussion instrument sounds, can cause significant problems for sound engineers. Another problem with acoustic instruments is that they can be very loud, often too loud for other musicians performing with a percussionist, or for neighbors of a percussionist practicing at home. Elaborate muting systems have been devised, such as plexiglass shields and drumhead muffling devices, but these often change the sound of the instruments to an unacceptable degree. Using less force to play the instrument changes the playability of the instruments as well as their acoustic output, and is generally not a viable solution for volume problems.

Electronic Percussion Instruments

Electronic percussion instruments do not produce sound directly. Instead, they use an electronic device (commonly referred to as a drum module) to produce electronic waveforms. These waveforms can be recordings of acoustic percussion instruments, recordings of other instrument sounds, or completely artificial waveforms. These waveforms can be captured by recording or amplification equipment as if they were actual sounds captured by microphones.

Drum modules do not require a percussionist or drummer for operation. They can be operated through computer interfaces, electronic musical keyboards, or other electronic devices, although percussionists are frequently used. To simulate the instrument layout and feel of acoustic percussion instruments, a number of drum pads are typically employed. Drum pads typically feature a rubber or mesh head that can be played in a similar manner as a drumhead or cymbal, and are placed on stands around the drummer to simulate acoustic instrument placement conventions. The pads feature electronic mechanisms, typically called triggers, that sense vibrations on the pads consistent with the impact of sticks, hands, beaters, and such, and then send signals to the drum module to indicate that a particular waveform should then be emitted. Pads can feature multiple triggers to better simulate acousting instrument behavior. For example, a pad meant to imitate a snare drum might have two sensors, which would allow the module to play ordinary drum beats, rim shots, and rim knocks. Triggers can be impact sensitive, allowing drummers some measure of volume control.

Electronic drums are desirable for a number of reasons. They are much easier to set up than acoustic instruments because they don't need microphones. Drum sounds are sent directly from the drum module to recording or amplification equipment. They can play sounds that acoustic percussion instruments are physically incapable of producing. Also, electronic instruments can be played much more quietly than acoustic instruments. Because the sound produced by a drum module has nothing to do with the actual modes of vibration on the pads, electronic pads are generally made of materials that create little noise when struck, like rubber or taut nylon mesh.

Electronic percussion instruments have a number of drawbacks that make them unacceptable to large numbers of musicians. First and foremost, they lack the range and depth of acoustic instruments. The sound an acoustic instrument makes is unique every time it is played, because of factors such as instrument tuning, strike location, and so on. An electronic drum, on the other hand, generates an identically shaped waveform every time it is played. This repetetiveness can be unpleasant to many listeners. Adding extra triggers to pads, or making them pressure sensitive, does little to alleviate this problem. Electronic percussion instruments also often lack the physical response characteristics (or “feel”) of their acoustic counterparts, which can limit their playability.

Electric Percussion Instruments

There is a third category of percussion instruments, electric percussion instruments, which attempts to combine the playability and uniqueness of acoustic instruments with the implementation simplicity of electronic instruments. In a short analogy, an electric percussion instrument is to percussion what an electric guitar is to guitars. Various models have been proposed.

Some models use a conventional acoustic drumhead with a magnetic speaker cone placed underneath, which is wired to act as a microphone. These systems do not have the dynamic range of an ordinary microphone. Furthermore, the speaker cones tend to be so large that they cannot be used in double-headed drums, because they disrupt the sound waves inside drums to an unacceptable degree.

Other proposed models involve pickups (coils of wire which detect changes in magnetic flux) to capture drumhead or cymbal vibrations. Pickup-based systems are at a disadvantage because they require special drumheads or cymbals that do not well emulate traditional acoustic drumheads or cymbals. Furthermore, the pickups tend to capture vibrations at a single point only, rather than sample the vibrational state of an entire cymbal or drumhead, as the sound from an acoustic instrument does. Furthermore, a single pickup is often very dense compared to a drumhead or cymbal. Placing a single pickup on a drumhead breaks the vibrational symmetry of the head, which tends to create a vibrational node (or dead spot) at that point. The single pickup can thus destroy the vibrational fidelity of a drumhead. The vibration of a whole drumhead or cymbal requires an impractical and costly number of pickups, as well as a complicated mixing aparatus.

### SUMMARY OF INVENTION

It is an object of the invention to provide electric percussion instruments that use vibrating surfaces to generate sound directly as well as electrical waveforms for recording or amplification purposes, thus combining the advantages of acoustic and electronic percussion instruments. This waveform is to be generated by creating a voltage difference between a layer of the vibrating surface portion and a sensor portion placed in close proximity. This sensor is connected to a voltage source through a source of electrical impedance (such as a resistor). When the electric percussion instrument receives an activating action from a performer, such as a stick strike, the voltage difference between vibrating surface and sensor will oscillate in response, and that voltage oscillation can be sent through an electronic circuit to external recording or amplification equipment.

It is a further object of the invention to allow for the use of any number of vibrating surfaces, to provide better acoustic range and better emulate acoustic percussion instruments.

It is another object of the invention to provide a system that can act as an electrical transducer, producing an electrical waveform as an output, an acoustic transducer, producing sound directly, or any combination of the two. For example, by choosing more solid vibrating surface materials, the invention may produce a large amount of direct sound output, as an acoustic percussion instrument would do. The percussionist may thus monitor the waveforms produced by the instruments by listening to them directly, as he/she would do for acoustic instruments, as well as through speakers or headphones, as he/she would do for electronic instruments. If the vibrating surface is made instead of materials with a large number of holes, such as a meshlike material with wide spacings in the weave, the invention will produce much less direct sound, but will still produce electrical signals that can produce audio waveforms in recording or amplification equipment. A percussionist can monitor his/her performance through loudspeakers or headphones.

Yet another object of the invention is to provide electric percussion instruments that can be produced and sold at a cost lower than that of traditional acoustic instruments plus the high quality microphones needed to record or amplify their sound.

A fuller understanding of the nature of the objects of the present invention will become apparent upon consideration of the following detailed description taken in connection with the accompanying drawings, wherin:

### BRIEF DESCRIPTION OF DRAWINGS

FIG. 1 is a side view of an electric drum, one embodiment of the invention,

FIG. 2 is a perspective view of a batter drumhead assembly,

FIG. 3 is a cross-sectional view of a batter drumhead assembly,

FIG. 4 is a cross-sectional view of a shell assembly with drumhead assemblies in place,

FIG. 5 is a top view of a sensor grid assembly,

FIG. 6 is a schematic view of an electric control module for an electric drum,

FIG. 7 is a perspective view of an electric cymbal, another embodiment of the invention,

FIG. 8 is a cross-sectional view of a cymbal assembly,

FIG. 9 is a schematic view of an electric control module for an electric cymbal.

### DETAILED DESCRIPTION

Double-Headed Electric Drum

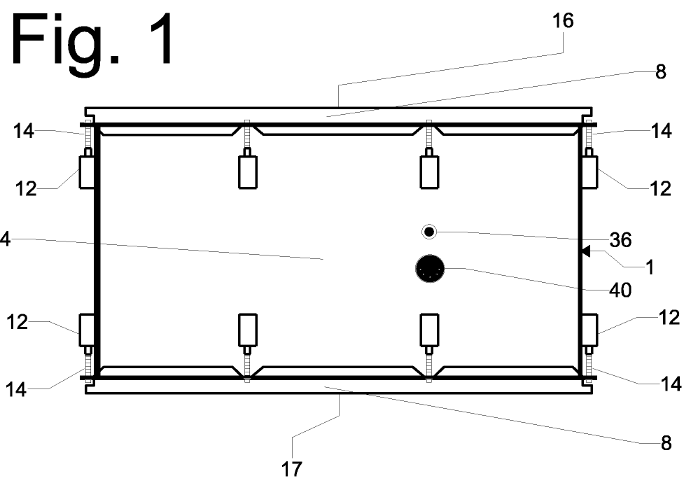

Referring now to the drawings, FIG. 1 depicts an embodiment of the invention, a double-headed electric drum 1. It consists of a cylindrical shell assembly 4 capped on top by a batter drumhead assembly 16, and on the bottom by a resonant drumhead assembly 17. The drumhead assemblies 16 and 17 are held taut on the drum by metal hoops 8, which are attached to the shell assembly by threaded tension rods 14 screwed into metal lugs 12. In this embodiment, there are six evenly-spaced lugs per shell end attached to the shell assembly. FIG. 1 also depicts an audio output jack 36, which is used to connect the drum to industry standard recording and amplification equipment. In this embodiment, the audio connection is through a standard ¼″ instrument cable (not shown). Power is supplied to the drum through the power input port 40, which connects to widely available grounded DC power supplies through a cable (not shown).

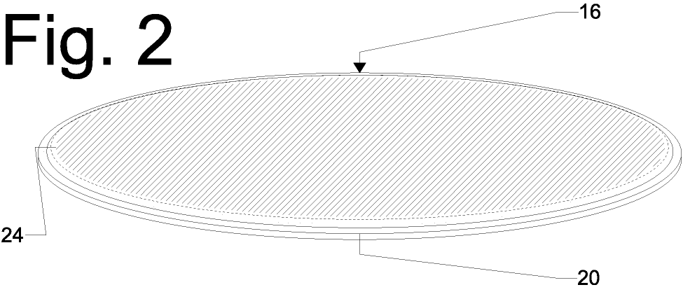

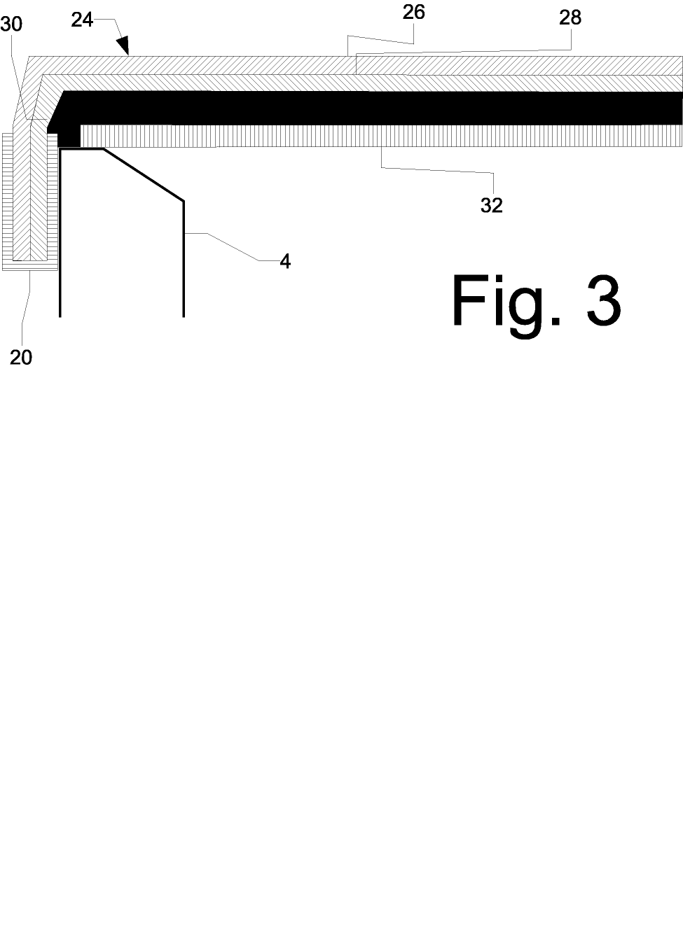

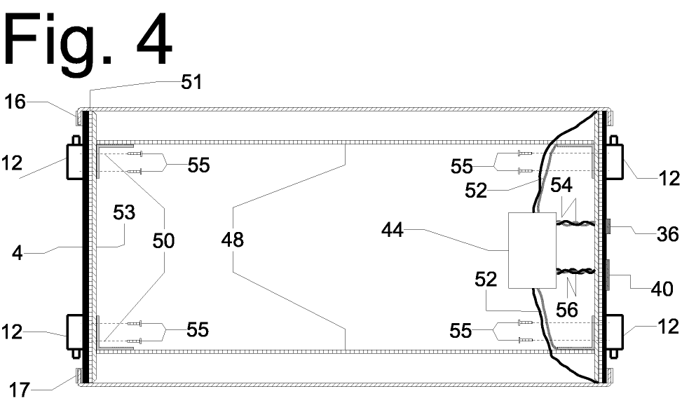

FIG. 2 depicts a perspective view of a batter drumhead assembly 16. A steel ring 20 is attached to a layered drumhead surface 24, by means of friction and an adhesive material. To better understand the composition of a drumhead assembly, FIG. 3 shows the batter drumhead assembly 16 in cross-section. Note that the drumhead surface is a multilayer material. In this embodiment, the surface layer 26 is a thin layer (typically less than 1 mm) of a plastic film, such as polyester. Directly beneath in the figure is the ground layer 28, made of a conducting material (such as aluminum foil) that makes electrical contact with the steel ring 20. The insulating layer 30, made of a material such as polyester film, isolates the ground layer 28 from the charged layer 32. The charged layer 32 is made from a conducting material, such as aluminum foil, and is raised to a particular voltage (such as 12 volts above ground) by the electric control module 44 depicted in FIG. 4. Electrical contact between the charged layer 32 and the electric control module 44 is made by a wire in the transducer cable 52, whose end is stripped of insulation to make contact with the charged layer through friction. Note that charged layer 32 is prevented from electrical contact with the shell assembly 4 through careful positioning and the insulating layer 30.

In this embodiment, FIG. 3 can also adequately depict the resonant drumhead assembly 17. The two drumhead assemblies are identical, except for the thicknesses of their surface layer 26. In this embodiment, for example, the surface layer 26 of a resonant drumhead assembly 17 is thinner than that of a batter drumhead assembly 16.

FIG. 4 depicts a cross-sectional view of the shell assembly in this embodiment. The shell body 4, which is cylindrical in shape, contains its own ground layer 51 made from a conducting material (such as aluminum or a metalized fabric). The ground layer 51 has electrical contact with the metal lugs 12, such as by direct physical contact inside the shell body 4. An insulating structural layer 53, made of a material like wood or plastic, provides additional structural stability and electrical insulation from the ground layer. The sensor grid assemblies 48 are mounted on the shell body 4 by mounting brackets 50, which in turn are connected to the shell body 4 by the same mounting screws 55 that hold on the metal lugs 12. The mounting brackets 50 comprise an electrically insulating material (such as nylon) to prevent inadvertent electrical contact between the sensor grid assemblies 48 and other parts of the electric drum. The transducer cable assemblies 52 contain a wire that makes electrical contact between the electric control module 44 and the sensor grid assemblies 48 for purposes of voltage control and audio signal capture. The audio output jack 36 and power input port 40 (shown in FIG. 4 in cross section) are connected to the electric control module 44 by the output jack cable 54 and power input cable 56, respectively.

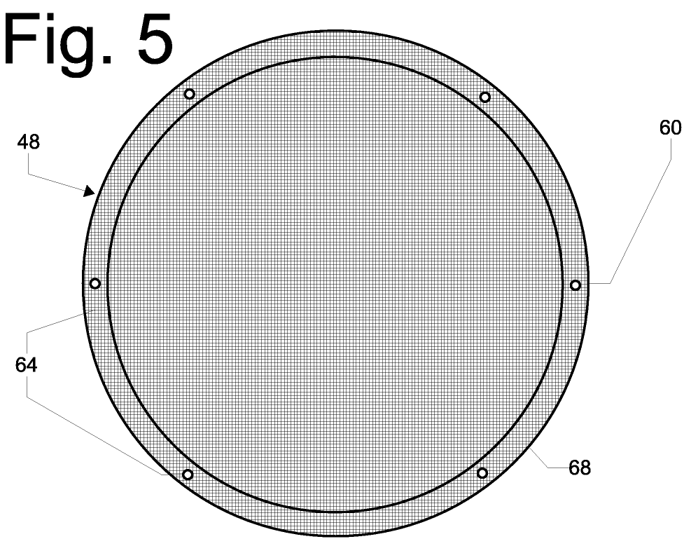

FIG. 5 depicts a top view of a sensor grid assembly 48. In this embodiment, a sensor grid assembly comprises a mounting ring 60 whose diameter is approximately that of the interior diameter of the drum shell body 4. A conducting mesh 68, made from a material such aluminum screen, mounted atop a mounting ring 60. Evenly spaced holes 64 are drilled in mounting ring 60 to allow the sensor grid to be affixed to mounting brackets 60. The fasteners used for this purpose can also be used as a contact for the appropriate terminal of the transducer cable 52.

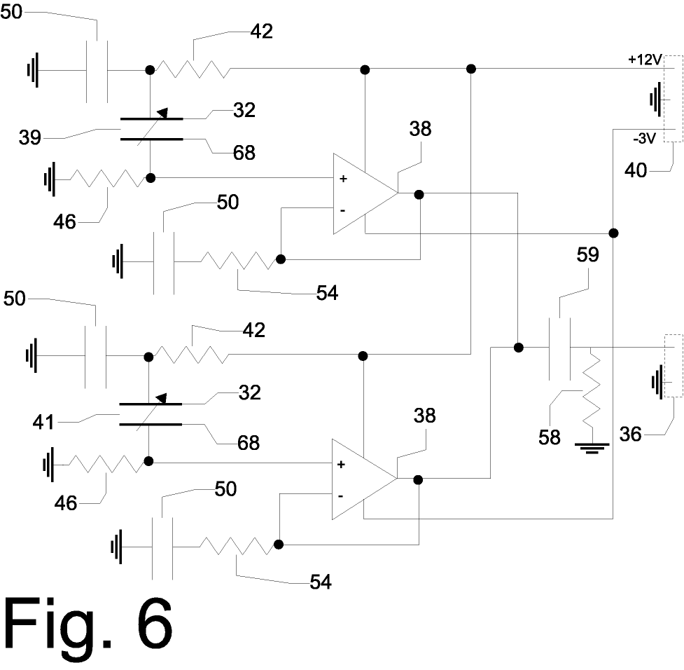

FIG. 6 is a schematic view for an electric control module 44. The power input port 40 comprises 3 terminals providing an electrical ground, a positive voltage (such as 12V above ground) and a negative voltage (such as 3V below ground). The audio output jack 36 comprises two terminals, one carrying the audio output signal of the drum and the other carrying ground. The audio output signal is generated by the batter variable capacitor 39 and the resonant variable capacitor 41. The batter variable capacitor 39 comprises the charged layer 32 and the conducting mesh 68 of the batter drumhead assembly 16 and its corresponding sensor grid assembly 48. Likewise, the resonant variable capacitor 41 comprises the charged layer 32 and the conducting mesh 68 of the resonant drumhead assembly 17 and its corresponding sensor grid assembly 48. A voltage difference across the variable capacitors 39 and 41 is maintained by a wire running from the positive terminal of the power input port 40 through a resistor 42 (commonly 1 M ohms). A filtering capacitor 50 (commonly 1 microfarad) also helps regulate the voltage. The audio signal appears as voltage fluctuations on the conducting meshes 68 when the charged layers 32 vibrate after the instrument is struck by the percussionist. These voltage oscillations are partly caused by the audio resistors 46 (typically 10 M ohms). The generated signals are routed through the op amps 38, merged to a common wire and fed through blocking capacitor 59 (typically 1.6 microfarads) connected to resistor 58 (typically 10 k ohms) for amplification and impedance matching purposes. Additional signal filtering occurs because of resistors 54 (typically 10 k ohms) and filtering capacitors 50.

Electric Cymbal

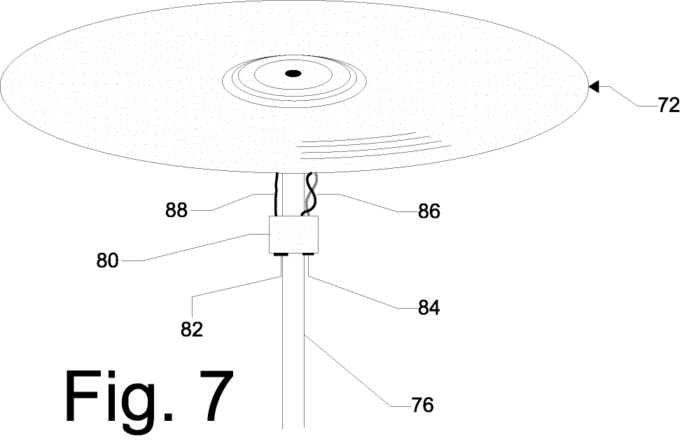

FIG. 7 depicts a perspective view of an electric cymbal. In this embodiment, it comprises a cymbal assembly 72 mounted on a cymbal stand 76. An electric control module 80 is also attached to the cymbal stand, connected to the cymbal assembly 72 by a ground wire 88 and a transducer cable 86. The electric control module 80 is connected to an external grounded DC voltage source through a power port 82, and to recording or audio amplification equipment through its audio output port 84, to which a ¼″ phone-type instrument cable is attached.

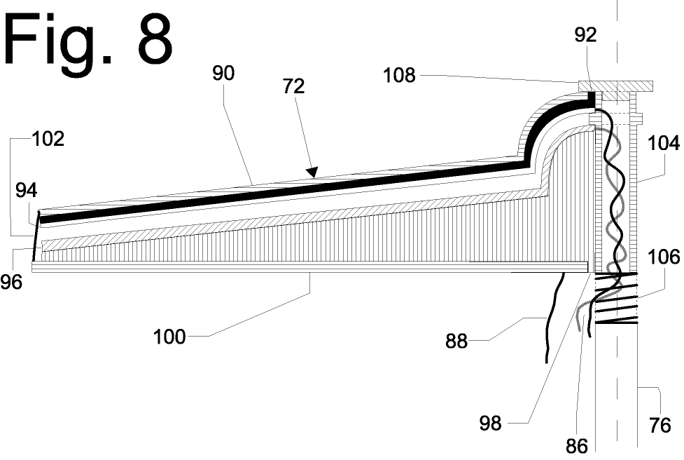

FIG. 8 shows a more detailed, cross-sectional view of a cymbal assembly 72, from the outer edge of the assembly to the geometric center (denoted by a dashed line). Note that in this embodiment of the invention, the cymbal assembly is radially symmetric. The top surface of the cymbal assembly is the batter surface 90, and typically comprises a machined and hammered metalic layer (such as bronze or aluminum) that defines the acoustic signature of the electric cymbal when struck. Beneath the batter layer 90 is a thin insulating layer 92 comprising an electrically insulating material (such as polyester). The insulating layer 92 electrically separates the batter surface 90 (which is electrically grounded, as discussed below) from the upper conducting layer 94, which in this embodiment is a thin layer of aluminum foil. The upper conducting layer 94 is in electrical contact with one of the wires of the transducer cable 86. Directly beneath the upper conducting layer 94, across a small air gap created by the axle 104, is the lower conducting layer 96, which in this embodiment is also made of aluminum foil, and is in electrical contact with the second wire of the transducer cable 86. The lower conducting layer 96 sits on top of a base layer 98 made from an electrically and acoustically insulating material such as polystyrene foam. The base layer 98 sits atop a ground layer 100, which in this embodiment is a relatively thick layer of metal such as aluminum. The ground layer is electrically grounded through the ground wire 88, connected to the electric control module 80. The ground layer is also electrically connected to the batter surface 90 through a mesh gasket 102, made from a material such as aluminum screening material and covering the outside edge of the cymbal assembly 72.

FIG. 8 also shows that the aforementioned cymbal assembly layers are mounted on an axle 104, essentially a hollow cylinder of a material such as nylon. In addition to sustaining the air gap between the upper and lower conducting layers 94 and 96, the axle allows passage and connection of the transducer cable 86. The axle 104 sits atop a coil spring 106, to allow the cymbal assembly to move freely after striking. The coil spring is mounted on top of the cymbal stand 76, and is capped on top by a metal cap 108.

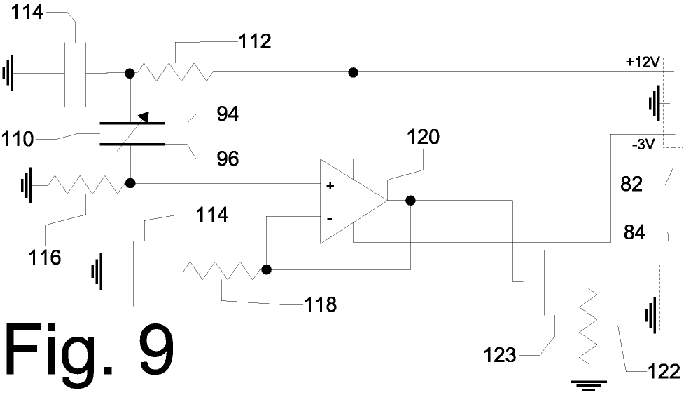

FIG. 9 is a schematic view of an electric control module 80. The power input port 82 comprises 3 terminals providing an electrical ground, a positive voltage (such as 12V above ground) and a negative voltage (such as 3V below ground). The audio output jack 84 comprises two terminals, one carrying the audio output signal of the electric cymbal and the other carrying ground. The audio output signal is generated by the variable capacitor 110 comprising the upper conducting layer 94 and the lower conducting layer 96 of the cymbal assembly 72. A voltage difference across the variable capacitor 110 is maintained by a wire running from the positive terminal of the power input port 82 through a resistor 112 (commonly 1 M ohms). A filtering capacitor 114 (commonly 1 microfarad) also helps regulate the voltage. The audio signal appears as voltage fluctuations on the lower conducting layer 96 when the upper conducting layer 94 vibrates after the instrument is struck by the percussionist. These voltage oscillations are partly caused by the audio resistor 116 (typically 10 M ohms). The generated signals are routed through the op amp 120 and fed through blocking capacitor 123 (typically 1.6 microfarads) connected to resistor 122 (typically 10 k ohms) for amplification and impedance matching purposes. Additional signal filtering occurs because of resistor 118 (typically 10 k ohms) and filtering capacitor 114.

1-18. (canceled)

19. An electric musical instrument transducer comprising: a) one or more air gapped parallel plate variable capacitors, where one of the plates of said variable capacitors is an electrically conducting, nonvibrating surface mounted close to a vibrating surface on a musical instrument that emits sound when said instrument is played, while the other of said plates is an electrically conducting surface that comprises, covers, or is embedded within said vibrating surface, combined with b) an electric circuit that applies a voltage difference to said variable capacitors, detects time-varying differences in voltage across said variable capacitors caused by vibrations in said vibrating surfaces, and converts said voltage differences into signals transmissible to and usable by audio recording and amplification equipment, where said signals at a given time correspond to the exact vibrational state induced in said vibrating surfaces of said musical instrument at that time by the player of said musical instrument.

20. An electric musical instrument transducer as described in claim 19, where said variable capacitors vibrate in response to direct mechanical stimulation of said vibrating surfaces by the player of said instrument.

21. An electric musical instrument transducer as described in claim 19, where said variable capacitors vibrate in response to vibrations in stretched strings mechanically connected to said vibrating surfaces, where said string vibrations are induced by the player of said instrument.

22. An electric musical instrument transducer as described in claim 19, where one of said variable capacitor plates comprises, covers, or is embedded within a soundboard.

23. An electric musical instrument transducer as described in claim 19, where one of said variable capacitor plates comprises, covers, or is embedded within a part of a musical instrument that functions as a soundboard.

24. An electric musical instrument transducer as described in claim 19, where one of said variable capacitor plates comprises, covers, or is embedded within a drumhead.

25. An electric musical instrument transducer as described in claim 19, where one of said variable capacitor plates comprises, covers, or is embedded within a cymbal.

26. An electric musical instrument transducer as described in claim 19, where one of said variable capacitor plates comprises, covers, or is embedded within a banjo membrane.

27. An electric musical instrument transducer as described in claim 19, where one of said variable capacitor plates comprises, covers, or is embedded within the solid portions of a hollow guitar body.

28. An electric musical instrument transducer as described in claim 19, where one of said variable capacitor plates comprises, covers, or is embedded within the solid portions of a hollow violin, viola, cello, or bass body.

29. An electric musical instrument transducer as described in claim 19, where one or more of said variable capacitor plates comprises a woven or mesh-like material.

30. An electric musical instrument transducer as described in claim 19, where said electric circuit comprises transistorized circuitry.

31. An electric musical instrument transducer as described in claim 19, where said electric circuit comprises vacuum tube circuitry.
